(19) United States
(12) Patent Application Publication
(10) Pub. No.: US 2012/0001997 A1
(43) Pub. Date: Jan. 5, 2012

(54) IMAGE FORMING APPARATUS AND METHOD OF THE SAME

(75) Inventor: Kazumasa TAKADA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/171,408

(22) Filed: Jun. 28, 2011

Related U.S. Application Data
(60) Provisional application No. 61/360,439, filed on Jun. 30, 2010.

(51) Int. Cl. B41J 2/435

(52) U.S. Cl. 347/224

(57) ABSTRACT

According to one embodiment, the control section forms a latent image pattern for detecting malfunction, on each photoconductive drum. The control section determines malfunction of each laser unit based on the detection result of each surface potential sensor with respect to the formed latent image pattern.

### CROSS-REFERENCE TO RELATED APPLICATIONS

This application is based upon and claims the benefit of priority from U.S. provisional applications 61/360,439, filed on Jun. 30, 2010, the entire contents of which are incorporated herein by reference.

### FIELD

Embodiments described herein relate generally to an image forming apparatus and a method of the same.

### BACKGROUND

An image forming apparatus exposes a photoconductive drum to a laser beam emitted from a laser unit, forms a latent image on the photoconductive drum by this exposure, and develops and prints the latent image on an image formed medium such as a paper sheet.

If the laser unit malfunctions and does not emit the laser beam, printing cannot be performed. It is desired that the malfunction of this laser unit can be appropriately detected.

### BRIEF DESCRIPTION OF THE DRAWINGS

FIG. 1 is a diagram showing an overall configuration of an embodiment.

FIG. 2 is a diagram showing configurations of a photoconductive drum and the circumference thereof according to an embodiment.

FIG. 3 is a diagram of main parts of an exposure unit according to an embodiment viewed from the side direction.

FIG. 4 is a diagram of main parts of an exposure unit according to an embodiment viewed from the upper direction.

FIG. 5 is a diagram showing a correspondence relationship between the arrangement of each laser diode in each laser unit and an image to be printed according to an embodiment.

FIG. 6 is a block diagram showing a control circuit according to an embodiment.

FIG. 7 is a block diagram showing a control circuit of an exposure unit according to an embodiment.

FIG. 8 is a diagram showing variation in the surface potential of each photoconductive drum according to an embodiment.

FIG. 9 is a flowchart showing control according to an embodiment.

FIG. 10 is a diagram showing an electrostatic latent image pattern, surface potential, and an average value of this surface potential according to an embodiment for an example of one-channel scanning in which a photoconductive drum is rotated at an ordinary speed and one laser diode in each laser unit is operated.

FIG. 11 is a diagram showing an electrostatic latent image pattern, surface potential, and an average value of this surface potential when one laser diode malfunctions in the example of FIG. 10.

FIG. 12 is a diagram showing an electrostatic latent image pattern, surface potential, and an average value of this surface potential according to an embodiment for an example of one-channel scanning in which a photoconductive drum is rotated at a ¼ speed of ordinary speed and one laser diode in each laser unit is operated.

FIG. 13 is a diagram showing an electrostatic latent image pattern, surface potential, and an average value of this surface potential when one laser diode malfunctions in the example of FIG. 12.

FIG. 14 is a diagram showing an electrostatic latent image pattern, surface potential, and an average value of this surface potential according to an embodiment for an example of two-channel scanning in which a photoconductive drum is rotated at an ordinary speed and two laser diodes in each laser unit are operated.

FIG. 15 is a diagram showing an electrostatic latent image pattern, surface potential, and an average of this surface potential when one laser diode malfunctions in the example of FIG. 14.

FIG. 16 is a diagram showing an electrostatic latent image pattern, surface potential, and an average value of this surface potential according to an embodiment for an example of two-channel scanning in which a photoconductive drum is rotated at a ½ speed of ordinary speed and two laser diodes in each laser unit are operated.

FIG. 17 is a diagram showing an electrostatic latent image pattern, surface potential, and an average of this surface potential when one laser diode malfunctions in the example of FIG. 16.

### DETAILED DESCRIPTION

In general, according to one embodiment, an image forming apparatus includes an image carrier; an exposure unit which includes a laser unit emitting laser beams, exposes the image carrier with the laser beams emitted from the laser unit, and forms a latent image on the image carrier by the exposure; a process unit which develops the latent image formed on the image carrier and transfers the developed image onto an image formed medium; a surface potential sensor which detects surface potential of the image carrier; and a control section which determines malfunction of the laser unit based on a detection result of the surface potential sensor.

Hereinafter, description will be made of an embodiment with reference to the drawings.

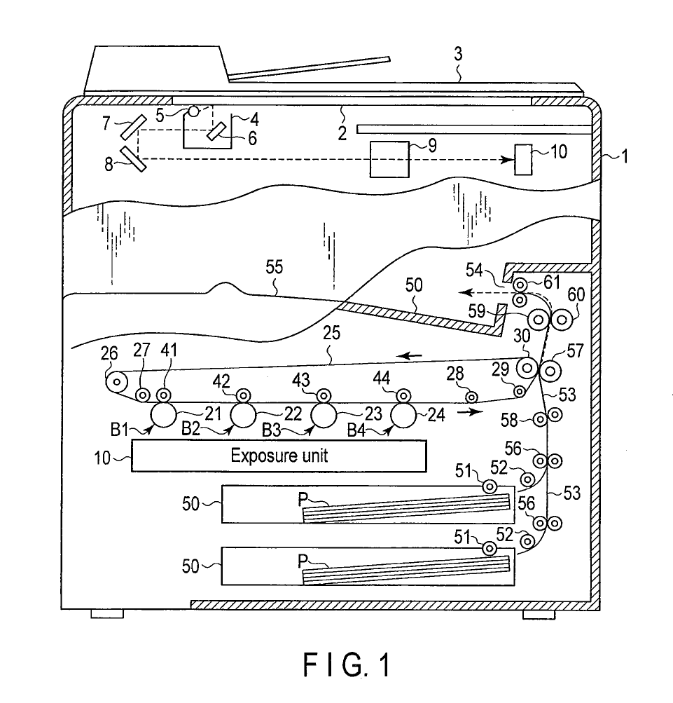

As shown in FIG. 1, an original document table (glass plate) 2 is arranged on the upper portion of an apparatus main body 1. A cover 3 is arranged on this original document table 2. A carriage 4 is arranged on the lower surface side of the original document table 2, and an exposure lamp 5 is arranged on the carriage 4. The carriage 4 is reciprocated along the lower surface of the original document table 2. The original document on the original document table 2 is exposed by turning on an exposure lamp 5 while the carriage 4 is moved forward. The image on the original document is optically read by this exposure. The read image is projected onto a CCD 10 through reflective mirrors 6, 7, and 8 and a lens block 9. The CCD 10 outputs an image signal corresponding to the read image.

The image signal output from the CCD 10 is processed by an image processing section 95 which will be described later and changed into image data. This image data is supplied to an exposure unit 11. The exposure unit 11 exposes and scans a photoconductive drum 21 for forming a yellow image, a photoconductive drum 22 for forming a magenta image, a photoconductive drum 23 for forming a cyan image, and a photoconductive drum 24 for forming a black image, respectively.

A transfer belt 25 is arranged on the photoconductive drums 21, 22, 23, and 24. This transfer belt 25 is stretched to a driver roller 26 and a driven roller 30, supplied with power from the driver roller 26, and rotated in the counterclockwise direction. Primary transfer rollers 41, 42, 43, and 44 are arranged at positions facing the photoconductive drums 21, 22, 23, and 24 so as to be movable in the vertical direction. The primary transfer rollers 41, 42, 43, and 44 are rotated while bringing the transfer belt 25 in contact with the photoconductive drums 21, 22, 23, and 24 by being displaced (moving downward) to the side of the transfer belt 25, and transfer visible images on the photoconductive drums 21, 22, 23, and 24 onto the transfer belt 25.

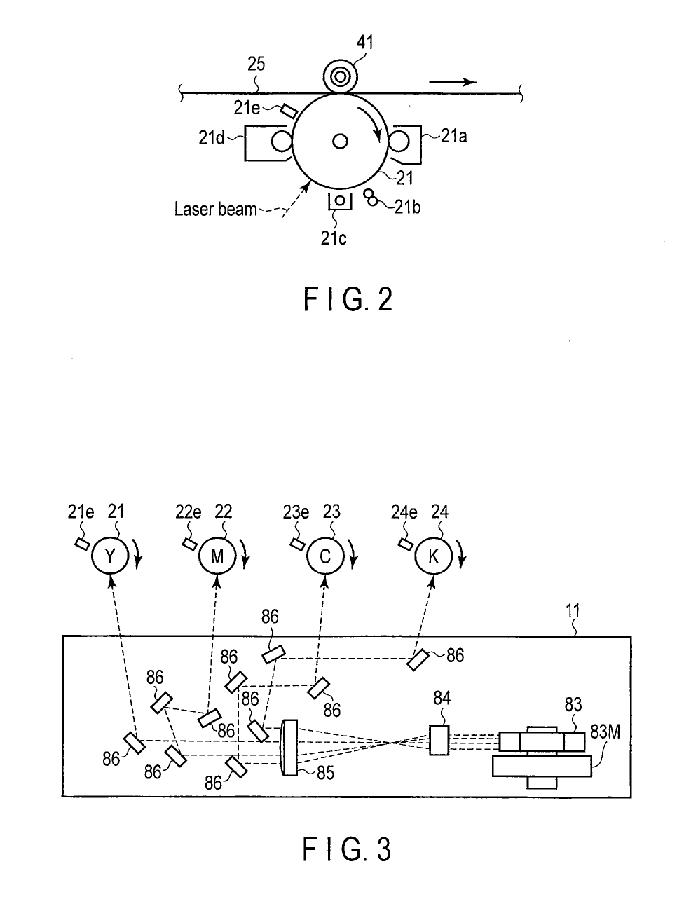

The configurations of the photoconductive drum 21 and the circumference thereof will be shown in FIG. 2. A cleaner 21a, a charge removing lamp 21b, an electrification unit 21c, a yellow developing unit 21d, and a surface potential sensor 21e are arranged in the circumference of the photoconductive drum 21. The cleaner 21a removes the developing material remaining on the surface of the photoconductive drum 21. The charge removing lamp 21b removes the electric charge remaining on the surface of the photoconductive drum 21. The electrification unit 21c electrostatically charges the surface of the photoconductive drum 21 by applying high voltage to the photoconductive drum 21. An electrostatic latent image is formed on the surface of the photoconductive drum 21 by exposing and scanning the surface of the photoconductive drum 21, which was already electrically charged, by the exposure unit 11. The developing unit 21d develops the yellow color of the electrostatic latent image on the surface of the photoconductive drum 21 to change it to a visible image by supplying a yellow developing material (toner) onto the surface of the photoconductive drum 21. The surface potential sensor 21e detects the surface potential Vf of the photoconductive drum 21.

The configurations of the other photoconductive drums 22, 23, and 24 and the circumferences thereof are the same. Therefore, the description thereof will be omitted.

Plural paper feed cassettes 50 are arranged under the exposure unit 11. These paper feed cassettes 50 contain paper sheets P as image formed media. The paper sheets P output from these paper feed cassettes 50 are supplied to a conveying path 53. This conveying path 53 extends to a paper discharge port 54 via the driven roller 30. The paper discharge port 54 faces a paper discharge tray 55. A secondary transfer roller 57 is arranged at a position facing the driven roller 30 in the conveying path 53 so as to interpose the transfer belt 25. A resist roller 58 is arranged at a position before the driven roller 30 and the secondary transfer roller 57. This resist roller 58 sends the paper sheet P into between the transfer belt 25 and the secondary transfer roller 57. The secondary transfer roller 57 transfers the visible image transferred on the transfer belt 25 on the paper sheet P sent from the register roller 58. A heat roller 59, a pressurizing roller 60, and a paper discharge roller 61 are arranged on the end of the conveying path 53.

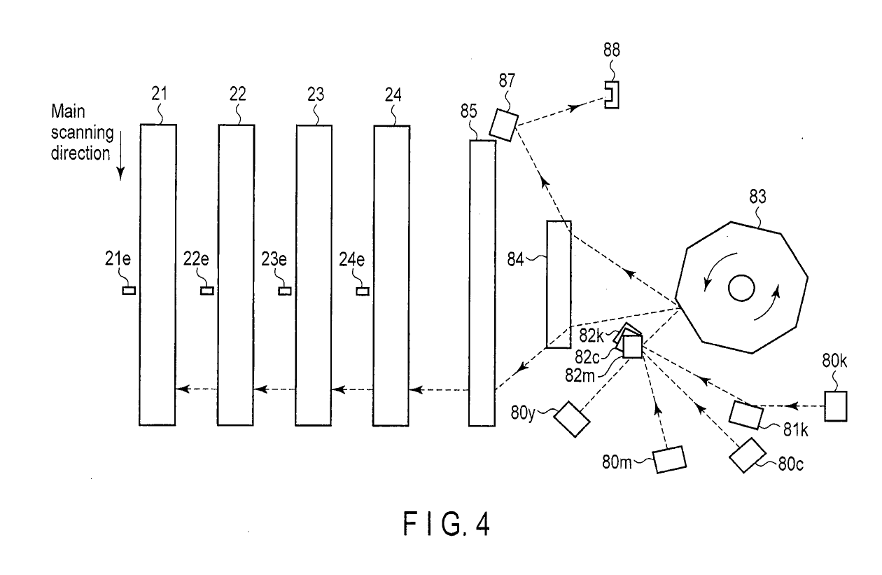

The main parts of the exposure unit 11 will be shown in FIGS. 3 and 4. FIG. 3 is a diagram viewed from the side direction. FIG. 4 is a diagram viewed from the upper direction.

A rotational polygon mirror 83 is irradiated with the laser beam emitted from a laser unit 80y for forming a yellow image. The polygon mirror 83 is rotated by the power of a polygon motor 83M and reflects the laser beam from the laser unit 80y toward the photoconductive drum 21. The photoconductive drum 21 is irradiated with the reflected laser beam through lenses 84 and 85 and plural mirrors 86. The photoconductive drum 21 is subjected to main scanning along the axial direction of the photoconductive drum 21 due to the rotation and the reflection of this polygon mirror 83, and this main scanning is repeatedly performed along with the rotation of the photoconductive drum 21. The repetition of this main scanning corresponds to sub scanning. The electrostatic latent image for a yellow image is formed on the photoconductive drum 21 by the main scanning and the sub scanning.

A laser detection unit 88 is irradiated with the laser beam emitted from the laser unit 80y through the polygon mirror 83, the lens 84, and the mirror 87 at the starting of the main scanning. This laser detection unit 88 detects the irradiated laser beam as a reference position of the main scanning.

The polygon mirror 83 is irradiated with the laser beam emitted from a laser unit 80m for forming a magenta image. The polygon mirror 83 reflects the laser beam from the laser unit 80m toward the photoconductive drum 22. The photoconductive drum 22 is irradiated with the reflected laser beam through the lenses 84 and 85 and plural mirrors 86. The photoconductive drum 22 is subjected to the main scanning along the axial direction of the photoconductive drum 22 due to the rotation and the reflection of this polygon mirror 83, and this main scanning is repeatedly performed along with the rotation of the photoconductive drum 22. The repetition of this main scanning corresponds to the sub scanning. The electrostatic latent image for a magenta image is formed on the photoconductive drum 22 by the main scanning and the sub scanning.

The polygon mirror 83 is irradiated with the laser beam emitted from a laser unit 80c for forming a cyan image. The polygon mirror 83 reflects the laser beam from the laser unit 80c toward the photoconductive drum 23. The photoconductive drum 23 is irradiated with the reflected laser beam through the lenses 84 and 85 and plural mirrors 86. The photoconductive drum 23 is subjected to the main scanning along the axial direction of the photoconductive drum 23 due to the rotation and the reflection of this polygon mirror 83, and this main scanning is repeatedly performed along with the rotation of the photoconductive drum 23. The repetition of this main scanning corresponds to the sub scanning. The electrostatic latent image for a cyan image is formed on the photoconductive drum 23 by the main scanning and the sub scanning.

The polygon mirror 83 is irradiated with the laser beam emitted from a laser unit 80k for forming a black image. The polygon mirror 83 reflects the laser beam from the laser unit 80k toward the photoconductive drum 24. The photoconductive drum 24 is irradiated with the reflected laser beam through the lenses 84 and 85 and plural mirrors 86. The photoconductive drum 24 is subjected to the main scanning along the axial direction of the photoconductive drum 24 due to the rotation and the reflection of this polygon mirror 83, and this main scanning is repeatedly performed along with the rotation of the photoconductive drum 24. The repetition of this main scanning corresponds to the sub scanning. The electrostatic latent image for a black image is formed on the photoconductive drum 24 by the main scanning and the sub scanning.

In addition, surface potential sensors 21e, 22e, 23e, and 24e are arranged at positions facing the photoconductive drums 21, 22, 23, and 24 as shown in FIGS. 3 and 4.

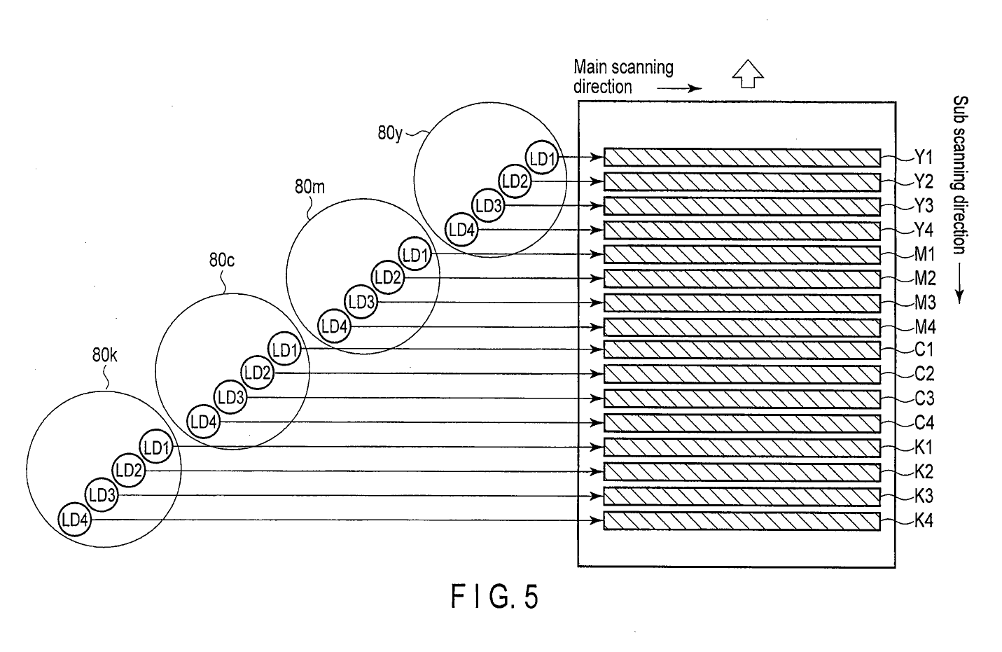

As shown in FIG. 5, the laser unit 80y includes plural light emission sections such as laser diodes LD1, LD2, LD3, and LD4. The laser beams emitted from these laser diodes LD1, LD2, LD3, and LD4 form line images Y1, Y2, Y3, and Y4 on the paper sheet P. It is possible to change the pitches between laser beams emitted from the laser diodes LD1, LD2, LD3, and LD4 by adjusting the rotational movement of the laser unit 80y in the circumferential direction. The other laser units 80m, 80c, and 80k also include the laser diodes LD1, LD2, LD3, and LD4.

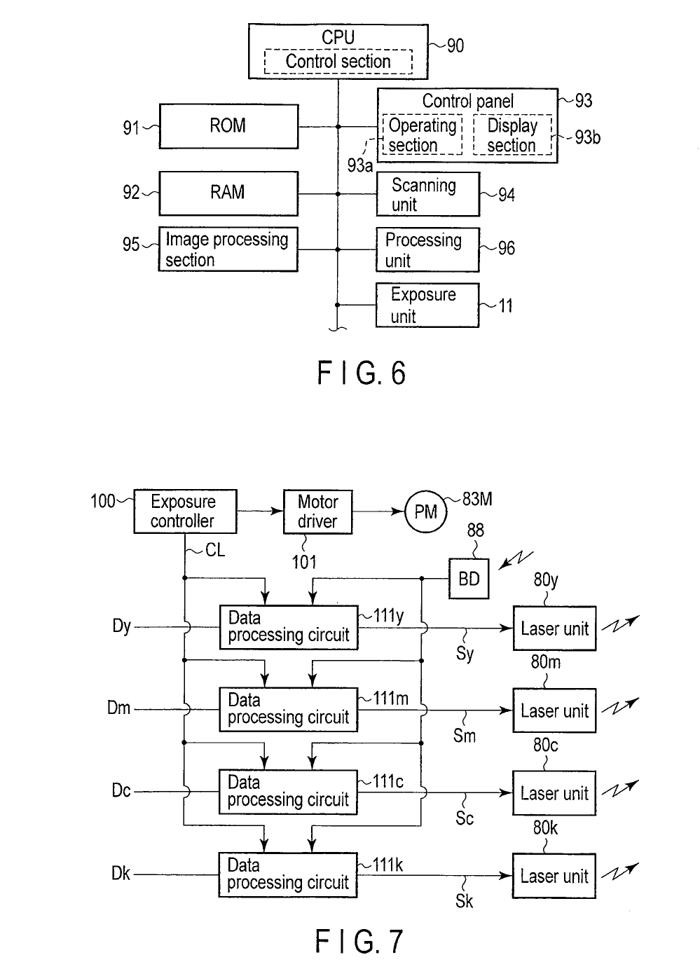

The control circuit of the apparatus main body 1 will be shown in FIG. 6.

A ROM 91, a RAM 92, a control panel 93, a scanning unit 94, an image processing section 95, a process unit 96, and the exposure unit 11 are connected to a CPU 90 as a main control unit.

The control panel 93 includes an operation section 93a which can be operated by a user and a display section 93b for displaying data for a user. The scanning unit 94 includes the carriage 4, the exposure lamp 5, the reflective mirrors 6, 7, and 8, the lens block 9, the CCD 10, and the like to optically read the image on the original document. The image processing section 95 performs processing on the image read by the scanning unit 94 and outputs yellow image data Dy, magenta image data Dm, cyan image data Dc, and black image data Dk. Such outputs are input to the exposure unit 11.

The process unit 96 includes the photoconductive drums 21, 22, 23, and 24, the transfer belt 25, the drive roller 26, the driven roller 30, the primary transfer rollers 41, 42, 43, and 44, the secondary transfer roller 57, and the like, develops each of the electrostatic latent images formed on the photoconductive drums 21, 22, 23, and 24, and transfers (prints) the developed image onto the paper sheet P.

The exposure unit 11 includes the configurations of FIGS. 3 and 4 and also includes an exposure controller 100, a motor driver 101, and data processing circuits 111y, 111m, 111c, and 111k shown in FIG. 7. The exposure controller 100 controls the motor driver 101 and the data processing circuits 111y, 111m, 111c, and 111k in response to the instruction from the CPU 90. The motor driver 101 drives the polygon motor 83M in response to the instruction from the exposure controller 100.

The data processing circuit 111y converts the input yellow image data Dy into a serial data signal Sy with a pulse width in accordance with the density represented by the yellow image data Dy and with a frequency in accordance with an image clock signal CL supplied from the exposure controller 100, synchronizes the serial data signal Sy with a detection signal of the laser detection unit 88, and outputs the synchronized signal. The data processing circuit 111m converts the input magenta image data Dm into a serial data signal Sm with a pulse width in accordance with the density represented by the magenta image data Dm and with a frequency in accordance with an image clock signal CL supplied from the exposure controller 100, synchronizes the serial data signal Sm with a detection signal of the laser detection unit 88, and outputs the synchronized signal.

The data processing circuit 111c converts the input cyan image data Dc into a serial data signal Sc with a pulse width in accordance with the density represented by the cyan image data Dc and with a frequency in accordance with an image clock signal CL supplied from the exposure controller 100, synchronizes the serial data signal Sc with a detection signal of the laser detection unit 88, and outputs the synchronized signal. The data processing circuit 111k converts the input black image data Dk into a serial data signal Sk with a pulse width in accordance with the density represented by the black image data Dk and with a frequency in accordance with an image clock signal CL supplied from the exposure controller 100, synchronizes the serial data signal Sk with a detection signal of the laser detection unit 88, and outputs the synchronized signal.

The laser unit 80y is operated in response to the serial data signal Sy and emits the laser beam for the exposure and the scanning with respect to the photoconductive drum 21. The laser unit 80m is operated in response to the serial data signal Sm and emits the laser beam for the exposure and the scanning with respect to the photoconductive drum 22. The laser unit 80c is operated in response to the serial data signal Sc and emits the laser beam for the exposure and the scanning with respect to the photoconductive drum 23. The laser unit 80k is operated in response to the serial data signal Sk and emits the laser beam for the exposure and the scanning with respect to the photoconductive drum 24.

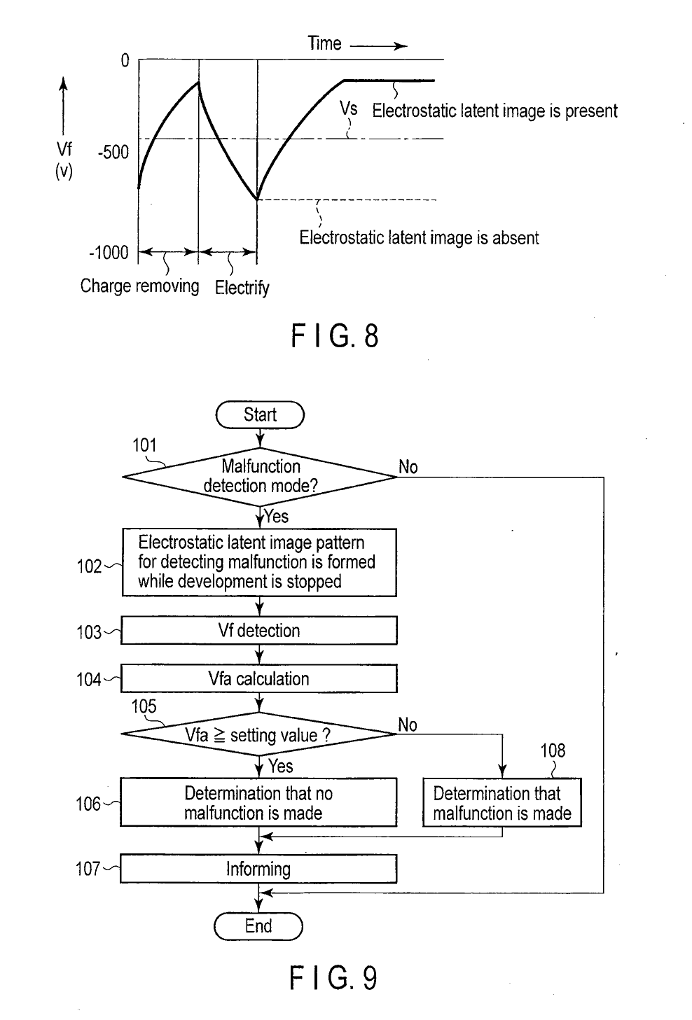

The variations in the surface potential detected by the surface potential sensors 21e, 22e, 23e, and 24e will be shown in FIG. 8. The surface potential at a position where the electrostatic latent image exists becomes higher than the electrification potential due to the negative charge release. The surface potential at a position where the electrostatic latent image does not exist is maintained in the electrification potential and becomes lower than the surface potential at the position where the electrostatic latent image exists.

The CPU 90 includes a control section of the following (1) as a main function.

(1) A control section which forms electrostatic latent image patterns for detecting malfunctions on the photoconductive drums 21, 22, 23, and 24 by the laser units 80y, 80m, 80c, and 80k while the development by the process unit 96 is stopped, determines the malfunctions of the laser diodes LD1, LD2, LD3, and LD4 in the laser units 80y, 80m, 80c, and 80k based on the detection result of the surface potential sensors 21e, 22e, 23e, and 24e with respect to these latent image patterns, and informs the determination result through the display of the display section 93b in the control panel 93, if a malfunction detection mode is set by the operation section 93a in the control panel 93.

Next, description will be made of the control of the CPU 90 when the malfunction detection mode is set, with reference to FIG. 9.

If the malfunction detection mode is set by the operation section 93a in the control panel 93 (YES in Act 101), the CPU 90 operates the laser unit 80y, 80m, 80c, and 80k and forms electrostatic latent image patterns for detecting malfunctions on the photoconductive drums 21, 22, 23, and 24 (Act 102).

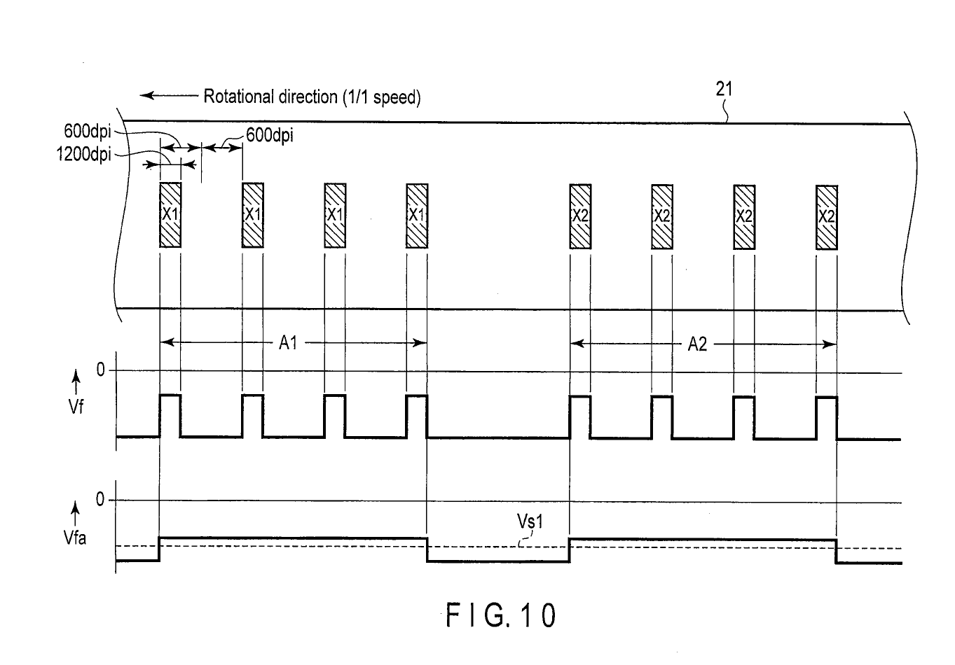

The electrostatic latent image patterns for detecting the malfunction, which are formed on the photoconductive drum 21, will be shown in FIG. 10. This is an example of one-channel scanning in which the photoconductive drum 21 is rotated at an ordinary speed and one laser diode of each laser unit is operated.

Plural electrostatic latent image patterns X1 for detecting malfunction are formed in a region A1 with a predetermined length along a rotational direction of the photoconductive drum 21 by plural operations of the laser diode LD1. Subsequently, plural electrostatic latent image patterns X2 for detecting malfunction are formed in a region A2 with a predetermined length along a rotational direction of the photoconductive drum 21 by plural operations of the laser diode LD2. Subsequently, plural electrostatic latent image patterns X3 for detecting malfunction are formed in a region A3 with a predetermined length along a rotational direction of the photoconductive drum 21 by plural operations of the laser diode LD3. Subsequently, plural electrostatic latent image patterns X4 for detecting malfunction are formed in a region A4 with a predetermined length along a rotational direction of the photoconductive drum 21 by plural operations of the laser diode LD4. The surface potential Vf at a position where such electrostatic latent image patterns are formed is higher than the surface potential Vf at a position where the electrostatic latent image patterns do not exist.

The CPU 90 detects the surface potential Vf in the region A1 as a formation target of each electrostatic latent image pattern X1 with the surface potential sensor 21e (Act 103) and calculates the average value Vfa of the detected potential Vf (Act 104). The CPU 90 detects the surface potential Vf in the region A2 as a formation target of each electrostatic latent image pattern X2 with the surface potential sensor 22e (Act 103) and calculates the average value Vfa of the detected potential Vf (Act 104). The CPU 90 detects the surface potential Vf in the region A3 as a formation target of each electrostatic latent image pattern X3 with the surface potential sensor 23e (Act 103) and calculates the average value Vfa of the detected potential Vf (Act 104). The CPU 90 detects the surface potential Vf in the region A4 as a formation target of each electrostatic latent image pattern X4 with the surface potential sensor 24e (Act 103) and calculates the average value Vfa of the detected potential Vf (Act 104).

The CPU 90 compares the average value Vfa of the surface potential Vf in the region A1 with a preset setting value Vs1 (Act 105). If all of each electrostatic latent image pattern X1 is formed, the average value Vfa of the surface potential Vf in the region A1 becomes equal to or greater than the setting value Vs1 (YES in Act 105). In such a case, the CPU 90 determines that there is no malfunction in the laser diode LD1 of the laser unit 80y (Act 106), and informs the determination result through the display of the display section 93b in the control panel 93 (Act 107).

The CPU 90 compares the average value Vfa of the surface potential Vf in the region A2 with a setting value Vs1 (Act 105). If all of each electrostatic latent image pattern X2 is formed, the average value Vfa of the surface potential Vf in the region A2 becomes equal to or greater than the setting value Vs1 (YES in Act 105). In such a case, the CPU 90 determines that there is no malfunction in the laser diode LD2 of the laser unit 80y (Act 106), and informs the determination result through the display of the display section 93b in the control panel 93 (Act 107).

The CPU 90 compares the average value Vfa of the surface potential Vf in the region A3 with a setting value Vs1 (Act 105). If all of each electrostatic latent image pattern X3 is formed, the average value Vfa of the surface potential Vf in the region A3 becomes equal to or greater than the setting value Vs1 (YES in Act 105). In such a case, the CPU 90 determines that there is no malfunction in the laser diode LD3 of the laser unit 80y (Act 106), and informs the determination result through the display of the display section 93b in the control panel 93 (Act 107).

The CPU 90 compares the average value Vfa of the surface potential Vf in the region A4 with a setting value Vs1 (Act 105). If all of each electrostatic latent image pattern X4 is formed, the average value Vfa of the surface potential Vf in the region A4 becomes equal to or greater than the setting value Vs1 (YES in Act 105). In such a case, the CPU 90 determines that there is no malfunction in the laser diode LD4 of the laser unit 80y (Act 106), and informs the determination result through the display of the display section 93b in the control panel 93 (Act 107).

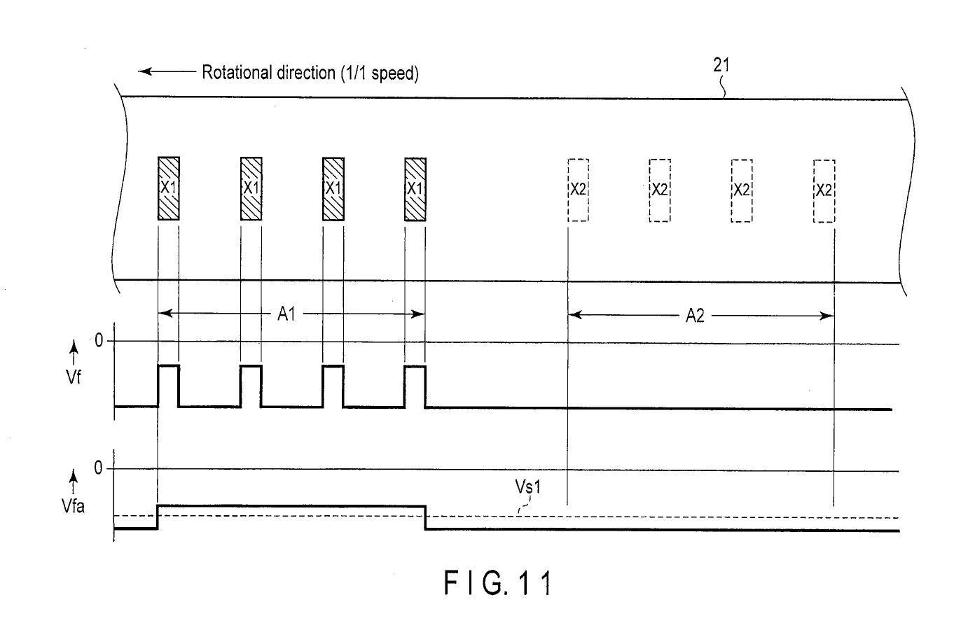

For example, if the laser diode LD2 of the laser unit 80y malfunctions and the laser diode LD2 does not emit the laser beam, each electrostatic latent image pattern X2 is not formed on the photoconductive drum 21 as shown in FIG. 11. In such a case, the surface potential Vf in the region A2 falls, and the average value Vfa becomes less than the setting value Vs1 (NO in Act 105). In such a case, the CPU 90 determines the malfunction of the laser diode LD2 of the laser unit 80y (Act 108), and informs the determination result through the display of the display section 93b in the control panel 93 (Act 107).

For example, if the laser diode LD2 of the laser unit 80y malfunctions and the laser beam emitted from the laser diode LD2 is weak, the average value Vfa of the surface potential Vf in the region A2 becomes less than the setting value Vs1 in the same manner.

As described above, it is possible to automatically and appropriately detect the malfunction of the laser diode LD2.

The CPU 90 executes the same malfunction detection processing on the laser diodes LD1, LD2, LD3, and LD4 of the laser units 80m, 80c, and 80k.

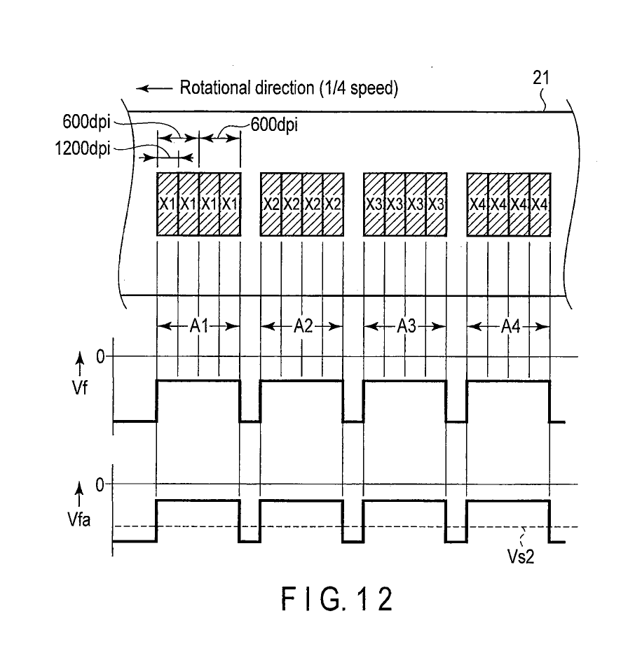

Next, another example of the electrostatic latent image patterns for detecting the malfunction, which are formed on the photoconductive drum 21, will be shown in FIG. 12. This is an example of one-channel scanning in which the photoconductive drum 21 is rotated at a ¼ speed of the ordinary speed and one laser diode of each laser unit is operated. Since the rotation speed of the photoconductive drum 21 is lowered to ¼, each electrostatic latent image pattern X1, each electrostatic latent image pattern X2, each electrostatic latent image pattern X3, and each electrostatic latent image pattern X4 are formed without any gap, respectively.

If there is no malefaction in the laser diodes LD1, LD2, LD3, and LD4 of the laser unit 80y, the average values Vfa of the surface potential Vf in the regions A1, A2, A3, and A4 become equal to or greater than a preset setting value Vs2. In such a case, the CPU 90 determines that there is no malfunction (Act 106), and informs the determination result through the display of the display section 93b in the control panel 93 (Act 107).

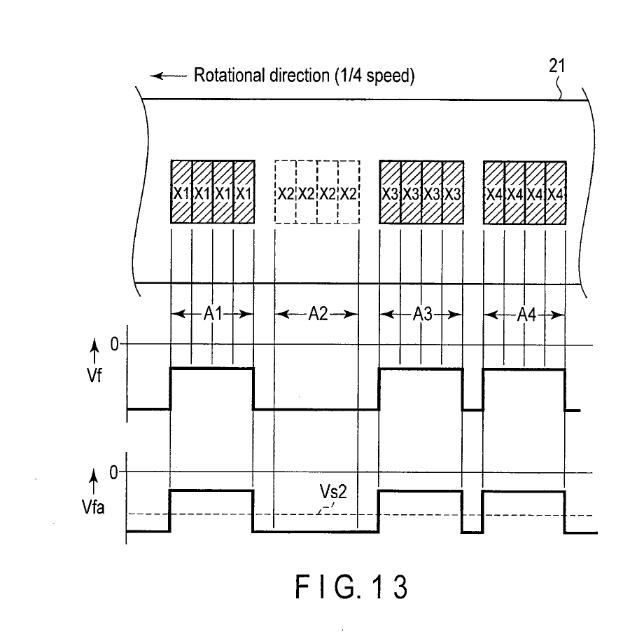

For example, if the laser diode LD2 malfunctions and the laser diode LD2 does not emit the laser beam, each electrostatic latent image pattern X2 is not formed on the photoconductive drum 21 as shown in FIG. 13. In such a case, the average value Vfa of the surface potential Vf in the region A2 becomes less than the setting value Vs2. Since the average value Vfa of the surface potential Vf in the region A2 is less than the setting value Vs2 (NO in Act 105), the CPU 90 determines the malfunction of the laser diode LD2 of the laser unit 80y (Act 108), and informs the determination result through the display of the display section 93b in the control panel 93 (Act 107).

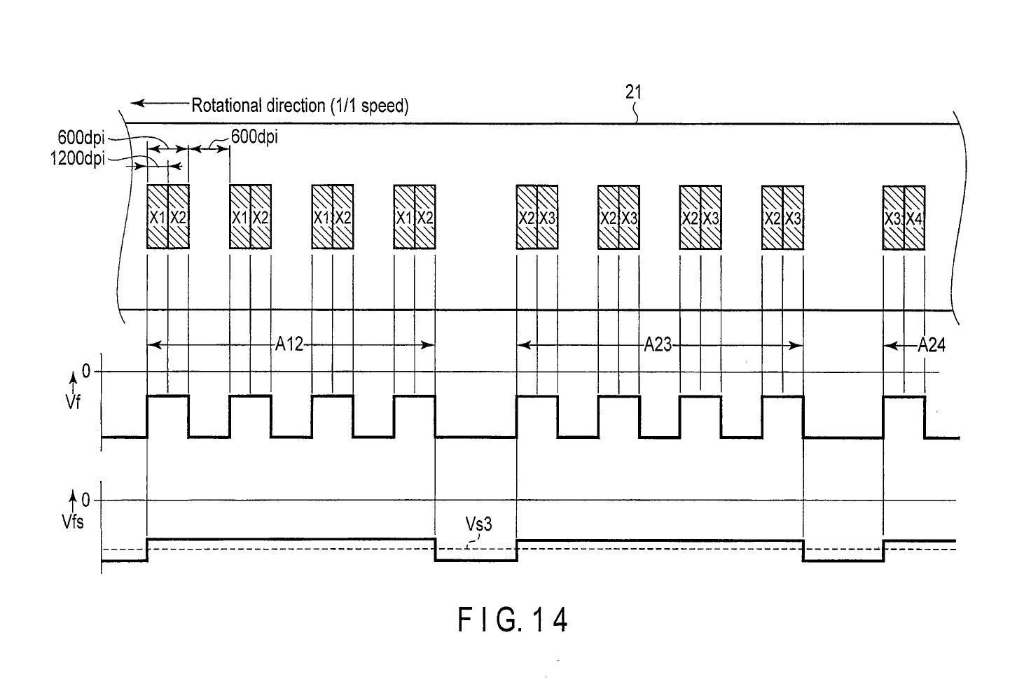

Moreover, another example of the electrostatic latent image patterns for detecting the malfunction, which are formed on the photoconductive drum 21, will be shown in FIG. 14. This is an example of two-channel scanning in which the photoconductive drum 21 is rotated at an ordinary speed and two laser diodes in each laser unit are operated.

Plural pairs of sequential patterns including the electrostatic latent image patterns X1 and X2 are formed in a region A12 with a predetermined length along the rotational direction of the photoconductive drum 21 by the plural repetition of the sequential operations of the laser diodes LD1 and LD2. Subsequently, plural pairs of sequential patterns including the electrostatic latent image patterns X2 and X3 are formed in a region A23 with a predetermined length along the rotational direction of the photoconductive drum 21 by the plural repetition of the sequential operations of the laser diodes LD2 and LD3. Subsequently, plural pairs of sequential patterns including the electrostatic latent image patterns X3 and X4 are formed in a region A34 with a predetermined length along the rotational direction of the photoconductive drum 21 by the plural repetition of the sequential operations of the laser diodes LD3 and LD4. Subsequently, plural pairs of sequential patterns including the electrostatic latent image patterns X4 and X1 are formed in a region A41 with a predetermined length along the rotational direction of the photoconductive drum 21 by the plural repetition of the sequential operations of the laser diodes LD4 and LD1.

If there is no malfunction in the laser diodes LD1, LD2, LD3, and LD4 of the laser unit 80y, the average values Vfa of the surface potential Vf in the regions A12, A23, A34, and A41 become equal to or greater than a preset setting value Vs3. Since the average values Vfa of the surface potential Vf in the regions A12, A23, A34, and A41 are equal to or greater than the setting value Vs3 (YES in Act 105), the CPU 90 determines that there is no malfunction (Act 106), and informs the determination result through the display of the display section 93b in the control panel 93 (Act 107).

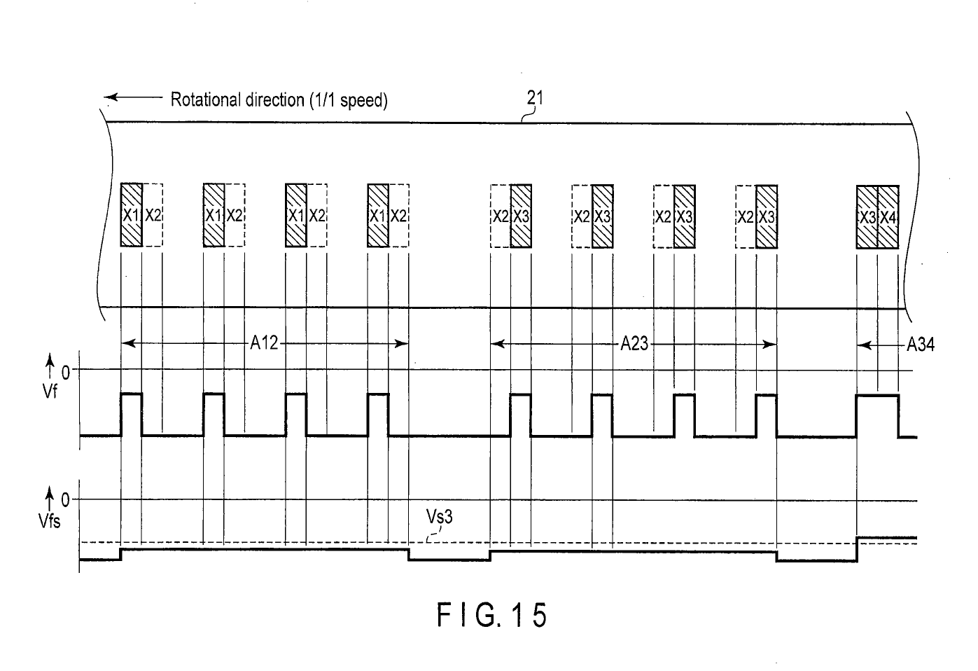

For example, if the laser diode LD2 malfunctions, and the laser diode LD2 does not emit the laser beam, each electrostatic latent image pattern X2 is not formed on the photoconductive drum 21 as shown in FIG. 15. In such a case, the average value Vfa of the surface potential Vf in the region A12 becomes less than the setting value Vs3 while the average value Vfa of the surface potential Vf in the region A23 becomes less than the setting value Vs3. Since the average values Vfa in the region A12 and the region A23 are less than the setting value Vs3 (NO in Act 105), the CPU 90 determines the malfunction of the laser diode LD2 of the laser unit 80y, and informs the determination result through the display of the display section 93b in the control panel 93 (Act 107).

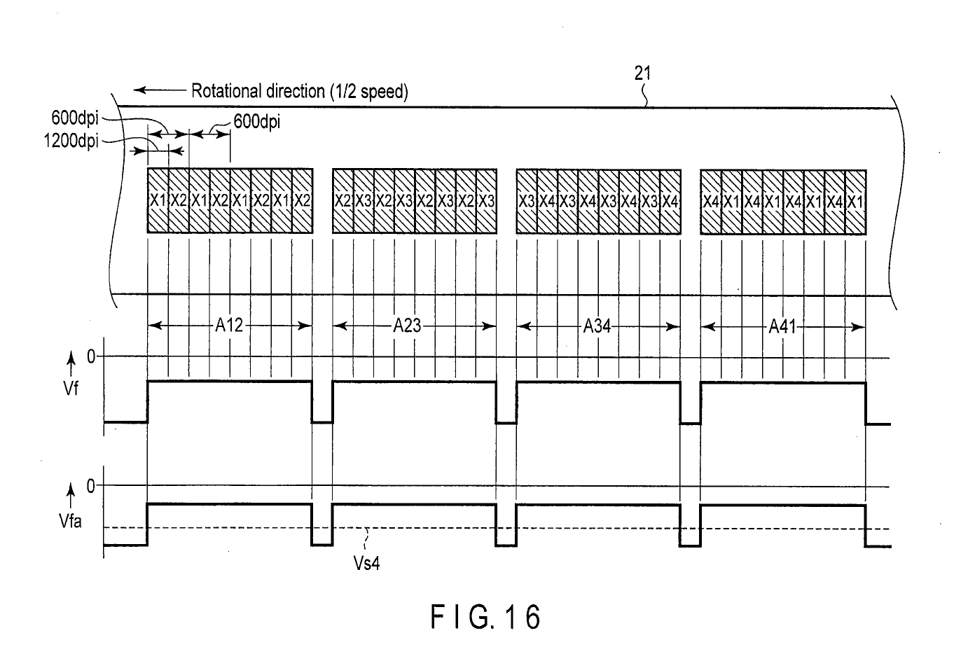

Furthermore, another example of the electrostatic latent image patterns for detecting the malfunction, which are formed on the photoconductive drum 21, will be shown in FIG. 16. This is an example of two-channel scanning in which the photoconductive drum 21 is rotated at a ½ speed of the ordinary speed and two laser diodes in each laser unit are operated. Since the rotation speed of the photoconductive drum 21 is lowered to ½, each sequential pattern including the electrostatic latent image patterns X1 and X2, each sequential pattern including the electrostatic latent image patterns X2 and X3, each sequential pattern including the electrostatic latent image patterns X3 and X4, and each sequential pattern including the electrostatic latent image patterns X4 and X1 are formed without any gap.

If there is no malfunction in the laser diodes LD1, LD2, LD3, and LD4 of the laser unit 80y, the average values Vfa of the surface potential Vf in the regions A12, A23, A34, and A41 become equal to or greater than a preset setting value Vs4. Since the average values Vfa of the surface potential Vf in the regions A12, A23, A34, and A41 are equal to or greater than the setting value Vs4 (YES in Act 105), the CPU 90 determines that there is no malfunction (Act 106), and informs the determination result through the display of the display section 93b in the control panel 93 (Act 107).

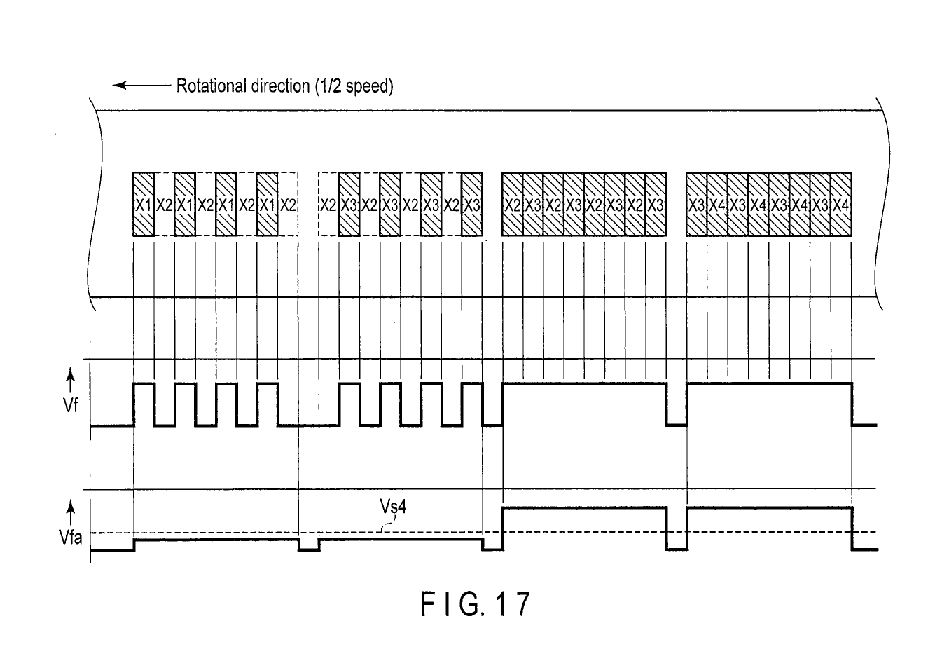

For example, if the laser diode LD2 malfunctions, and the laser diode LD2 does not emit the laser beam, each electrostatic latent image pattern X2 is not formed on the photoconductive drum 21 as shown in FIG. 17. In such a case, the average value Vfa of the surface potential Vf in the region A12 becomes less than the setting value Vs4 while the average value Vfa of the surface potential Vf in the region A23 becomes less than the setting value Vs4. Since the average values Vfa of the surface potential Vf in the region A12 and the region A23 are less than the setting value Vs4 (NO in Act 105), the CPU 90 determines the malfunction of the laser diode LD2 of the laser unit 80y (Act 108), and informs the determination result through the display of the display section 93b in the control panel 93 (Act 107).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changed in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image carrier;
an exposure unit which includes a laser unit emitting laser beams, exposes the image carrier with the laser beams emitted from the laser unit, and forms a latent image on the image carrier by the exposure;
a process unit which develops the latent image formed on the image carrier and transfers the developed image onto an image formed medium;
a surface potential sensor which detects surface potential of the image carrier; and
a control section which determines malfunction of the laser unit based on a detection result of the surface potential sensor.

2. The apparatus of claim 1, wherein the control section forms a latent image pattern for detecting malfunction on the image carrier by the exposure unit if a malfunction detection mode is set, and determines the malfunction of the laser unit based on a detection result of the surface potential sensor with respect to this latent image pattern.

3. The apparatus of claim 1, wherein the laser unit includes plural light emission sections which respectively emit laser beams.

4. The apparatus of claim 3, wherein the control section forms a latent image pattern for detecting malfunction on the image carrier by each light emission section of the laser unit if a malfunction detection mode is set, and determines the malfunction of each light emission section based on a detection result of the surface potential sensor with respect to this latent image pattern.

5. The apparatus of claim 1,
wherein the image carrier includes plural photoconductive drums; and
wherein the laser unit includes plural laser units which respectively correspond to the photoconductive drums.

6. The apparatus of claim 1, wherein the control section stops development by the process unit if a malfunction detection mode is set.

7. The apparatus of claim 1, wherein the control section informs the determination result.

8. The apparatus of claim 1, further comprising:
a control panel including an operation section and a display section.

9. The apparatus of claim 8, wherein the control section informs the determination result through display of the display section in the control panel.

10. An image forming apparatus comprising:
plural photoconductive drums for forming a color image;
an exposure unit which includes plural laser units emitting laser beams, exposes each photoconductive drum with the laser beams emitted from the laser units, and forms a latent image on each photoconductive drum by the exposure;
a process unit which develops the latent image formed on each photoconductive drum and transfers the developed image onto an image formed medium;
plural surface potential sensors which respectively detect surface potential of each photoconductive drum; and
a control section which determines malfunction of each laser unit based on a detection result of each surface potential sensor.

11. The apparatus of claim 10, wherein the control section forms a latent image pattern for detecting malfunction on each photoconductive drum by the exposure unit if a malfunction detection mode is set, and determines the malfunction of each laser unit based on a detection result of each surface potential sensor with respect to this latent image pattern.

12. The apparatus of claim 10, wherein the photoconductive drums include a photoconductive drum for forming a yellow image, a photoconductive drum for forming a magenta image, a photoconductive drum for forming a cyan image, and a photoconductive drum for forming a black image.

13. The apparatus of claim 10, wherein the laser units include a laser unit for forming a yellow image, a laser unit for forming a magenta image, a laser unit for forming a cyan image, and a laser unit for forming a black image.

14. The apparatus of claim 10, wherein each laser unit includes plural light emission sections which respectively emit laser beams.

15. The apparatus of claim 10, wherein the control section forms latent image patterns for detecting malfunction on each photoconductive drum by each light emission section of the laser unit if a malfunction detection mode is set, and determines the malfunction of each light emission section based on a detection result of each surface potential sensor with respect to these latent image patterns.

16. The apparatus of claim 10, wherein the control section stops development by the process unit if a malfunction detection mode is set.

17. The apparatus of claim 10, wherein the control section informs the determination result.

18. The apparatus of claim 10, further comprising:
a control panel including an operation section and a display section.

19. The apparatus of claim 18, wherein the control section informs the determination result through display of the display section in the control panel.

20. A control method of an image forming apparatus including:
an image carrier;
an exposure unit which includes a laser unit emitting laser beams, exposes the image carrier with the laser beams emitted from the laser unit, and forms a latent image on the image carrier by the exposure;
a process unit which develops the latent image formed on the image carrier and transfers the developed image onto an image formed medium; and
a surface potential sensor which detects surface potential of the image carrier,
the method comprising:
determining malfunction of the laser unit based on a detection result of the surface potential sensor.
